(19) United States
(12) Patent Application Publication
(10) Pub. No.: US 2012/0011772 A1
(43) Pub. Date: Jan. 19, 2012

(54) Garden planter

(76) Inventor: Duane E. Savage, Chicago, IL (US)

(21) Appl. No.: 12/804,283

(22) Filed: Jul. 19, 2010

(51) Int. Cl. A01G 9/02

(52) U.S. Cl. 47/65.6

(57) ABSTRACT

A planter may include a plurality of walls. Each of the walls have an outer surface, a first end and a second end, a cavity positioned between the first end and the second end, and at least one aperture extending from the outer surface to the cavity. The planter may also include a liquid permeable cover that traverses the at least one aperture and a connection means for connecting a first end of a first wall to a second end of a second wall. The planter may also be adapted to engage a framework. The framework has a frame that includes a plurality of frame members and a lattice attached to the frame. The framework may be pivotally coupled to the planter.

### FIELD OF THE INVENTION

The present invention relates to the field of planters, and, in particular, to raised bed planters having sufficient drainage and aeration, and adapted to engage other agricultural device attachments such as a framework or aeration system.

### BACKGROUND OF THE INVENTION

People use planters and, in particular, raised bed planters to grow plants, crops and other vegetation. In a raised bed planter, the planting material in the bed typically dries out and warms up more quickly in the spring when compared to the earth. This aspect makes raised beds attractive to many growers who have a shortened growing season.

Raised bed planters are also attractive to growers of varying abilities, skill levels, and locations. Advantages of raised bed planters stem from the fact that the soil is easy to nourish with compost, peat or fertilizers and is less expensive than traditional gardening because the gardener is focused on the growing area. Additionally, the maintenance of a raised bed planter is minimal, watering may be focused and problems with soil compaction are virtually eliminated. Furthermore, raised bed planters may be used in a variety of locations such as urban environments where there is a lack of sufficient space to maintain a full garden. Finally, raised bed gardens may also easily be sectioned off and protected from wildlife. These features contribute to larger yields, better quality harvest, and a generally healthier, more productive garden.

To have a successful raised bed garden, one needs access to sun light and adequate soil. Additionally, the raised bed garden should be easy to assemble and disassemble. Furthermore, features that produce a successful garden include at least soil aeration, irrigation, and drainage. Previous attempts to create and optimize these individual features of raised bed planters have each been met with limited and varying success.

Attempts to provide aeration have required turning the soil over or tilling, both of which require a significant amount of labor. Typically, previous raised bed planters are made of heavy materials such as wood and assembled with nails or bolts. Therefore, the planters are heavy, burdensome to assemble, and are not conducive to ready disassembly and/or reconfiguration. Irrigation systems have included complex systems of tubes or have not sufficiently dispersed water to the center of the planter without over saturating portions of the planting material.

Raised bed planters may also utilize a variety of agricultural device attachments and accessories to aid in the growing of plants and crops. Such agricultural devices include frameworks, layout systems, shading cloths, plastic grow covers, etc. These devices create their own problems in terms of implementation, storage and ease of use.

What is needed is a comprehensive solution to address the problems and inadequacies presented by raised bed planters. A raised bed planter needs to be easy to assemble and disassemble, provide improved drainage and aeration, and function successfully in a variety of locations. The raised bed planter additionally needs to be adapted to support multiple agriculture device accessories and attachments, such as a framework, that are each easy to implement, use and store.

The previous attempts to achieve such a result remain inadequate to provide a versatile raised bed planter that is easy to install and use while also improving yield of crops, plants or vegetation grown therein. To achieve the goals of a raised bed planter that provides sufficient aeration and drainage, it is important to have a simple and efficient apparatus that is easy to assemble, disassemble, or store. The present invention is directed to satisfying these and other needs. Furthermore, the present invention allows growers to isolate the crops from other soil contaminants.

### SUMMARY OF THE INVENTION

Disclosed herein is a new and improved planter improved drainage and aeration. In accordance an aspect of the planter, a wall of the planter may include at least one aperture and at least one liquid permeable cover to traverse the at least one aperture.

In accordance with another aspect of the wall of the planter, the wall may also include an outer surface and an internal cavity. The at least one aperture may then extend from the at least one outer surface to the internal cavity.

In accordance with another aspect of the planter, a planter may include a plurality of walls, wherein at least one wall of the plurality of walls includes a first aperture. The planter may further include a first liquid permeable cover to traverse the first aperture and a connection means for connecting two or more walls. The plurality of walls may define a planting space.

In accordance with another aspect of the planter, the connection means may include a second aperture, a second outer surface, and a second internal cavity. The second aperture may extend from the second outer surface of the connection means to the second internal cavity of the connection means.

In accordance with another aspect of the planter, the planter may be adapted to engage a framework. The framework may include a plurality of frame members and a lattice attached to the frame. The framework may be pivotally coupled to the planter.

In accordance with another aspect of the planter, a raised bed planter may include a plurality of walls. Each of the walls has an outer surface, a first end and a second end, and a cavity positioned between the first and the second ends. The planter also includes at least one aperture extending from the outer surface to the cavity. Additionally, the planter may include a liquid permeable cover to traverse the at least one aperture and a connection means for connecting the first end of a first wall to the second end of a second wall.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The foregoing and clear advantages of the invention will become apparent upon reading the following detailed description and upon reference to the drawings.

FIG. 1 is a perspective view of an exemplary embodiment of a raised bed planter;

FIG. 2 is a partial perspective view of an assembly drawing of walls and connection means of the raised bed planter;

FIG. 3 is a partial cross-sectional view of the raised bed planter in operation;

FIG. 4 is a flowchart of the construction and installation of the raised bed planter;

FIG. 5 is a perspective view of a raised bed planter adapted to be coupled with a framework;

FIG. 6 is a side view of a planter adapted to be coupled with a framework utilizing a support;

FIGS. 7A and 7B are side views of a planter adapted to be coupled with a collapsible framework;

FIG. 8 is a cross-sectional view of the raised bed planter adapted to include an aeration system; and

FIG. 9 is a cross-sectional view of the raised bed planter adapted to include a cloth water wick system.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

The configuration and construction of components, as illustrated herein, is new to the art of raised bed planters. In this description, the configuration and construction of individual components of raised bed planter may be utilized independently of each particular component, and the components are not limited to any particular construction or configuration.

Instead, the systems and methods are as stated in the accompanying claims.

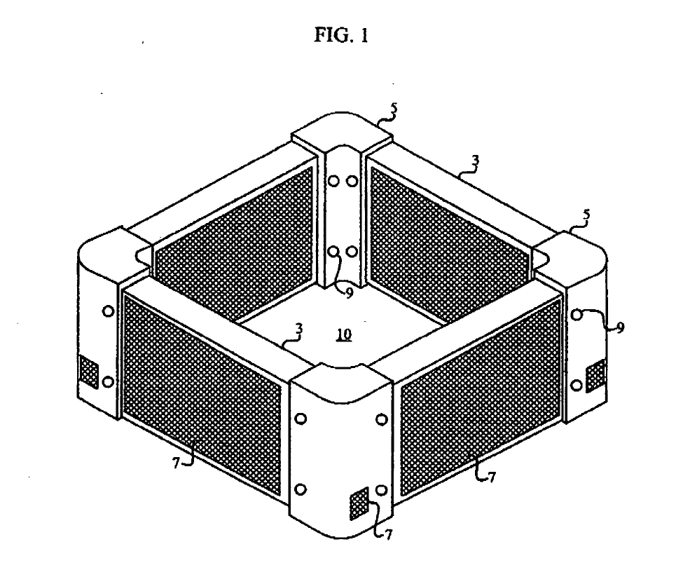

FIG. 1 shows a perspective view of a raised bed planter 1 to grow plants, crops and other vegetation. Raised bed planter 1 includes walls 3, connection means 5, a planting space 10, and a cover 7. The raised bed planter 1 may be constructed to be modular allowing several raised bed planters 1 to be engaged together in a variety of ways.

Wall 3 may provide the structure and the frame for planter 1. Wall 3 may be made of, but is not limited to, PVC, weather-treated wood or wood products, stamped aluminum, injection molded plastics, galvanized sheet metal, all equivalents, and combinations thereof. An example of a specific material that may be used for wall 3 is an eight inch Form-A-Drain produced by Certainteed corporation.

Typically, the material used for wall 3 may be durable and may provide integrity to the overall structure of planter 1. To promote the esthetic appeal of planter 1, walls 3 may be constructed so as to present the appearance of having a wood grain finish. Additionally, wall 3 may be a board or a block, be strait or curved, include planar or non-planar surfaces, or include a cavity. Wall 3 may vary in height, length, width and thickness. Wall 3 may also be adjustable to vary the overall dimensions of planter 1.

Connection means 5 may connect two or more walls 3 to form a continuous barrier. Connection means 5 may include, but is not limited to, adhesives, welds, water seals, preformed ridged connectors, adjustable or flexible connectors, and all equivalents. A flexible connection means 5 such as a corrugated connection means 5 may allow the angle between two walls to be varied thus allowing planter 1 to be constructed in a variety of shapes. An example of a specific connection means 5 may be an eight-inch Form-A-Drain, 90-degree corner produced by Certainteed corporation. Connection means 5 may be removable or permanent.

In FIG. 1, connection means 5 is depicted as a preformed, rigid connector adapted to engage and retain ends of walls 3 to form planter 1. Connection means 5 is depicted as being secured to walls 3 through use of screws 9. Connection means 5 may also be secured to wall 3 through use of an adhesive, weld, latch, clasp, fastener, clip, bolt, and all equivalents.

Planting space 10 may be fully or partially defined by walls 3 and/or connection means 5. In FIG. 1, planting space 10 is fully defined by walls 3 and connection means 5. In instances where walls 3 and connection means 5 may only define a portion of a barrier, the remainder of the barrier may be defined by any suitable structure or boundary that will aid in retaining materials in planting space 10. Planting space 10 may be occupied by a variety of materials, in a variety of combinations and configurations, as will be explained below.

Suitable structures or boundaries to function as the remainder of the barrier may include, but are not limited to, a wall, a tree, an inclined surface, a railroad tie, stone, etc. When additional structures or boundaries are used as a barrier, walls 3 and connection means 5 may be adapted to abut or be secured to such structures or boundaries. The variety of objects that may be used as additional barriers exemplifies the versatility of planter 1 and the variety of locations planter 1 may be implemented. Planter 1 may also be deployed or installed on any surface allowing the use of abandoned hard space, such as basketball courts, concrete patios, asphalt driveways and so forth.

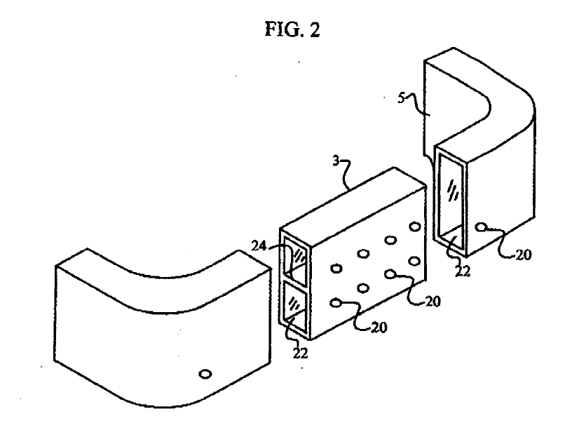

Referring to FIG. 2, a partial perspective view of an assembly drawing of the walls 3 and cover 7 is shown. Wall 3 may include an aperture 20, a cavity 22, and an internal support 23.

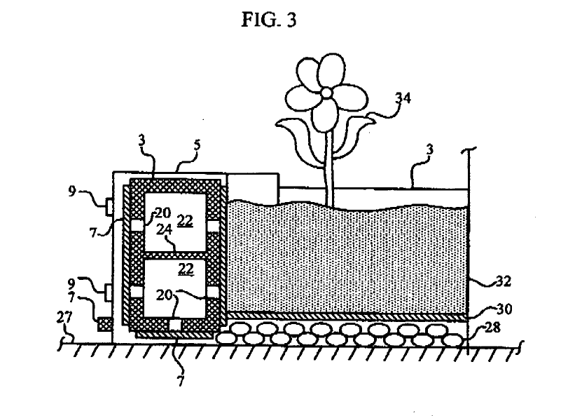

Referring to FIG. 3, a partial cross-sectional view of planter 1 in operation is shown. Aperture 20 may allow water to drain from a planting material 32 in planting space 10 of planter 1 or allow air to circulate and enter a planting material 32 sub-grade. The shape, size and number of apertures 20 on wall 3 may all vary. Additionally, aperture 20 may be adapted to direct the flow of moisture from planter 1. For instance, aperture 20 may be a threaded fitting of a conventional size to be coupled with a conventional garden hose to promote controlled drainage away from planter 1.

Referring to FIG. 2 and FIG. 3, cavity 22 may exist in wall 3 and may extend the length of wall 3 thus making wall 3 hollow. Additionally, cavity 22 may operate in conjunction with apertures 20 to promote drainage and aeration.

To promote drainage, apertures 20 may be positioned on wall 3 adjacent to planting space 10 may allow moisture to drain into cavity 22. Apertures 20 positioned on the remaining surfaces wall 3 may then allow moisture to drain from cavity 22 out of and away from planter 1. In terms of aeration, cavity 22 may promote the circulation of air via apertures 20 into planting material 32 occupying planting space 10.

Internal support 23 may be present in wall 3 to provide structural support to wall 3. Internal support may divide cavity 22 into multiple cavities 22 and operate to direct the flow of moisture during drainage. The thickness, angle, and configuration of internal support 23 may all vary to promote at least the structural integrity of wall 3.

Referring again to FIG. 1, cover 7 is used to cover, or traverse, apertures 20. Cover 7 may include, but is not limited to, a mesh screen, a weed fiber barrier, and all equivalents. Such materials are known in the art and commonly sold in garden supply stores. Cover 7 may be liquid permeable and operate to freely allow the transfer of air and liquid while not allowing the passage of planting material 32, insects or larva. A single cover 7 may cover multiple apertures 20 or multiple covers 7 may be used to cover each aperture 22 individually. Cover 7 may be positioned over or within aperture 22. Cover 7 may be incorporated into and be included in wall 3 or may be coupled to wall 3 by means of an adhesive, rope, a holder, and all equivalents.

Turning again to FIG. 2, connection means 5 may also include an aperture 20, a cavity 22, and a cover 7. Drainage and aeration may then occur via connection means 5 in a similar manner as described above in relation to wall 3.

FIG. 3 is a partial cross-sectional view of planter 1 in operation and placed on a surface 27. Planting space 10 may be occupied by materials including base material 28, matting 30, planting material 32, and plant 34.

Surface 27 may include any surface to support planter 1 such as, but not limited to, the earth such as dirt or stone, a solid surface such as concrete or asphalt, a raised surface such as a table or pedestal, and all equivalents. Base material 28 operates to facilitate drainage and aeration when planter 1 is placed on a solid surface 7 such as, but not limited to, concrete, asphalt, and all equivalents. Base material 28 may include, but is not limited to, rocks, gravel, bark, or any other suitable material.

Matting 30 provides a barrier between base material 28 and planting material 32 and allows drainage and aeration for planting material 32. The material of matting 30 is similar to cover 7 and may include, but is not limited to, a mesh screen, a weed fiber barrier, and all equivalents. Such materials are known in the art and commonly sold in garden supply stores. Matting 30 may be water permeable and operate to freely allow the transfer of air and water while not allowing the passage of planting material 32, insects or larva.

Planting material 32 may include, but is not limited to, soil, peat moss, mulch, compost, all equivalents, and combinations thereof. Planting material 32 operates to promote the growth of plant 34.

When planter 1 is placed on a solid surface such as concrete, the combination of base material 28 and matting 30 operate to promote drainage and aeration of planting material 32. Additionally, such a configuration allows planter 1 to quickly and easily be removed, deconstructed, or repositioned without extensive effort or cleanup.

When planter 1 is placed on surface 27 that is earth or dirt, base material 28 and/or matting 30 may be omitted thus allowing the roots of plant 34 to extend into the earth or dirt that is surface 27. When planter 1 is placed on a hard surface such as concrete, rather than a soft surface, walls 3 may be sized to a height allows planting space 10 to be filled with planting material 32 to a depth sufficient to allow the roots of plant 34 to grow to their full potential.

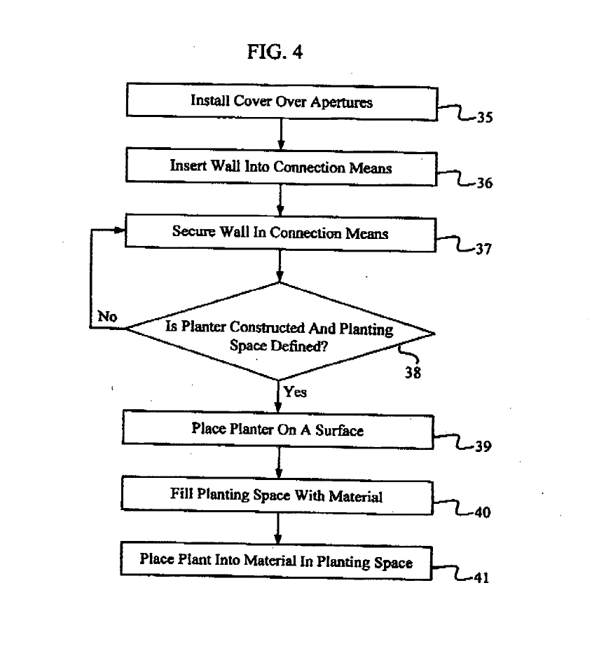

The flowchart in FIG. 4 shows how planter 1 may be constructed and installed. In step 35, covers 7 may be installed on walls 3 to cover apertures 20. In step 36, an end of a first wall 3 may be inserted into connection means 5. In step 37, screws 9 may be inserted in connection means 5 to secure wall 3 in place. In step 38, steps 36 and 37 may be repeated until a planter 1 constructed with a defined planting space 10. In step 39, planter 1 may be placed on a desired surface 27. In step 40, planting space 27 may be filled with materials such as base material 28, matting 30, and planting material 32. In step 41, a plant 34 may be placed into the material occupying planting space 10. The steps can be performed in various orders or multiple steps may be performed simultaneously and no specific amount of time is required between any two steps or combinations of steps.

The construction of planter 1 may be provided through an example of a grower receiving planter 1 as a kit. The kit may include four walls 3 as described above including cover 7 over each aperture 20, four connection means 5 adapted to engage and retain ends of walls 3, and screws to secure walls 3 with connection means 5. The kit including these components is lightweight, easy to ship, and easy to assemble.

The grower assembles the kit into planter 1 by inserting the ends of wall 3 into connection means 5 and inserting screws 9 into connection means 5 to secure walls 3. The grower repeats this process until the grower has planter 1 with defined planting space 10. Once assembled, the grower may have a four foot by four foot planter 1 that may be positioned on surface 27.

Next, the grower places planter 1 in a desired location on surface 27. The grower may then fill the planting space 10 of planter 1 with materials purchased such as base material 28, matting 30, and planting material 32. The grower may place base material 28 into planting space 10 on top of surface 27 to a depth of approximately one half inch. Next, the grower may position matting 30 on top of base material 28. Planting material 32 may be deposited on top of matting 30 to occupy the remainder of planting space 10 to a depth sufficient to allow the roots of plant 34 to grow. Finally, to complete the installation of planter 1, the grower will place plant 34 into planting material 32.

Once planter 1 is completely installed, plant 34 may be watered. When watered, excess moisture may drain via apertures 20 and cavities 22 of wall 3 and connection means 5. Moisture may first pass from planting material 32, through cover 7 and aperture 20 into cavity 22 located on wall 3. Cover 7 operates to retain planting material 32 in planting space 10 and prevents planting material 32 from migrating into cavity 22. From cavity 22, the moisture exits planter 1 via additional apertures 20 and covers 7 of walls 3 or migrates to connection means 5 and exists planter 1 via apertures 20 and covers 7 of connection means 5. Aeration of planting material 32 occurs via the same apertures 20, covers 7, and cavities 22 of walls 3 and connection means 5.

Planter 1 may also be adapted to support agricultural device attachments and accessories such as, but not limited to, a framework, a layout system, a shading cloth, plastic grow covers, irrigation systems, aeration systems, and water wicking systems.

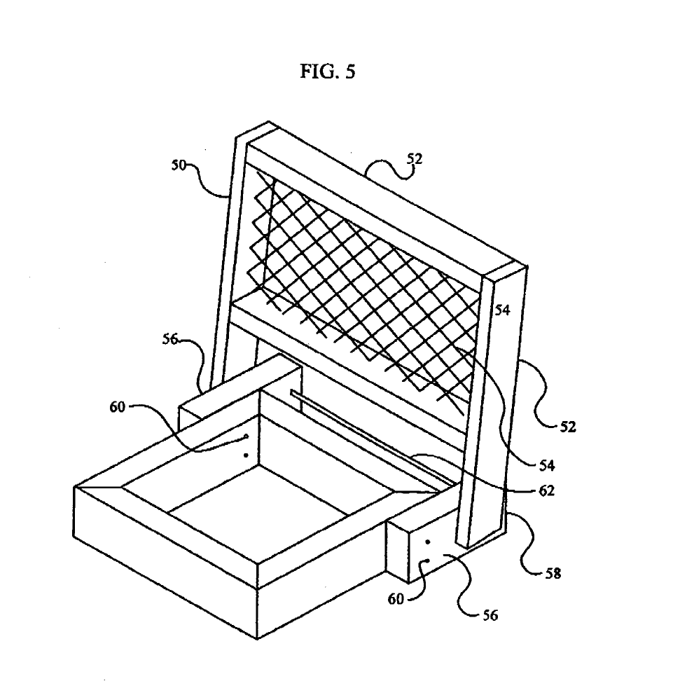

FIG. 5 is a perspective view of planter 1 adapted to include a framework 50. When growing vine-like plants, a framework may be installed to permit these plants to climb upwards. Framework 50 may be freestanding or leaned against a structure or object such as, but not limited to, a home, wall, fence, tree, and all equivalents. Framework 50 may be positioned and angled to collect an optimal amount of sunshine. Framework 50 saves gardening space, makes harvesting easier and reduces disease. Framework 50 may include a frame including frame members 52 and lattice 54 as is generally known in the art.

Frame members 52 may be constructed of, but not limited to, wood, plastic, metal, all equivalents, and combinations thereof. An example of a specific material that may be used for frame members 52 is a four inch Form-A-Drain produced by Certainteed corporation.

Lattice 54 may include, but is not limited to, a galvanized wire, a chicken wire, slats, rope, wire, and all equivalents. Lattice 54 may be attached to frame members 52 using any and all conventional methods such as, but not limited to, hooks, staples, rope, ties, nails, pegs, fasteners, clasps, and all equivalents.

Framework 50 may be adapted to be coupled to planter 1 via attachment means 56. Attachment means 56 functions to couple attachments and other agricultural devices to planter 1. Attachment means 56 may couple agricultural device attachments and accessories, such as framework 50, to planter 1 permanently or temporarily in either a fixed, removable, or moveable manner. Attachment means 56 may include, but is not limited to, screws, bolts, adhesives, hinges, latches, sockets, clamps, tape, ropes, Velcro®, bands, ties, pins, all equivalents, and combinations thereof.

In the exemplary embodiment of FIG. 5, attachment means 56 pivotally couples framework 50 to planter 1. In this manner, framework 50 may be positioned against a structure or object at a variety of angles. Framework 50 may also be leaned forward to make it easier to harvest and remove a yield without the need for a ladder or stepstool. The ability to rotate framework 50 around attachment means 56 may also make framework 50 easier to clean off at the end of the growing season.

Attachment means 56 as depicted in FIG. 5 may include a mounting bracket 58, bolt assembly 60, and shaft 62. Mounting bracket 58 may be coupled to planter 1 using bolt assembly 60 or any other acceptable means to couple mounting bracket 58. Bolt assembly 60 may include a bolt, a washer, and a nut. Bolt assembly 60 may be made of a corrosive resistant material such as, but not limited to, stainless steel, brass, and all equivalents. Shaft 62 may then pass through mounting bracket 56 and frame member 52 to pivotally couple framework 50 to planter 1.

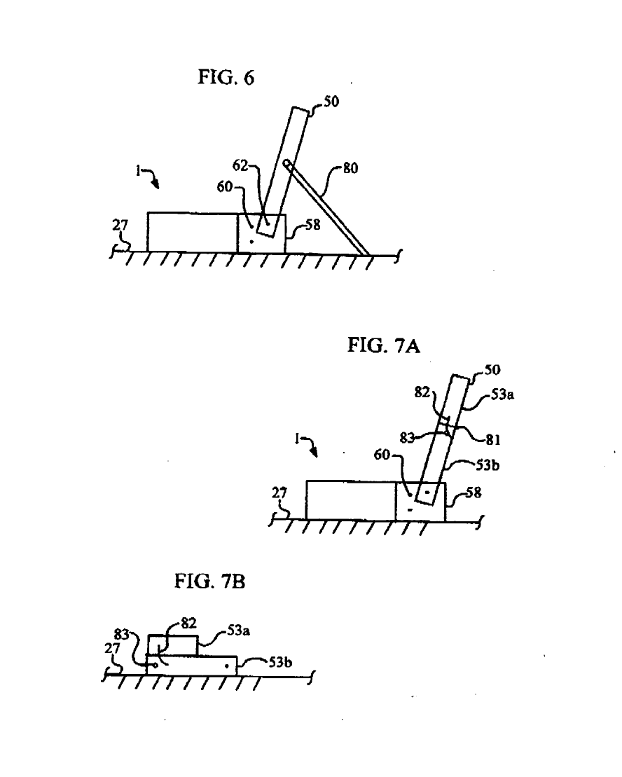

Referring to FIG. 6, a side view of framework 50 adapted to utilize support 80 is depicted. When framework 50 may not be leaned against a structure or object, support 80 may be coupled to framework 50. Support 80 may be permanently or removably coupled to framework 50 and may be positioned at any position on framework 50 sufficient to securely support framework 50. Additionally, support 80 may be adjustable in length to vary the angle of framework 50 relative to surface 27. If necessary, more than one support 80 may be used to secure framework 50. Support 80 may be coupled to the ground permanently or removably to resist wind.

In FIG. 6, framework 50 is depicted as a single, solid structure. However, framework 50 may be designed to be expandable, adjustable, contractible, or collapsible or modular. Referring to FIGS. 7A and 7B, a side view of an exemplary embodiment of framework 50 is depicted wherein framework 50 may be collapsible and may be pivotally coupled to planter 1. Frame member 52 may be divided into upper frame 53a and lower frame 53b. Upper frame 53a may be coupled to lower frame 53b so as to be removable or collapsible. Upper frame 53a may be coupled to lower frame 53b by means such, but not limited to any fasteners known in the art.

In FIG. 7A and FIG. 7B, a hinge 81 is utilized to couple upper frame 53a and lower frame 53b. When framework 50 is fully extended, upper frame 53a and lower frame 53b may be secured in place by any fasteners. In FIG. 7A, a hook 82 and eyelet 83 may be utilized to secure upper frame 53a and lower frame 53b.

From a fully extended position in FIG. 7A, framework 50 may be collapsed to store framework 50 as depicted in FIG. 7B. When framework 50 is not in use, framework 50 may then be easily stored and/or framework 50 and planter 1 may be easily covered during winter months. To collapse framework 50 of FIG. 7A, hook 82 is removed from eyelet 83 to release upper frame 53a. Upper frame 53a may then be rotated about hinge 81 to rest upper frame 53a on lower frame 53b. The entire frame is then rotated about attachment means 56 to compactly store the entire frame as shown in FIG. 7B. In this manner, framework 50 may be collapsed and easily stored without disassembly.

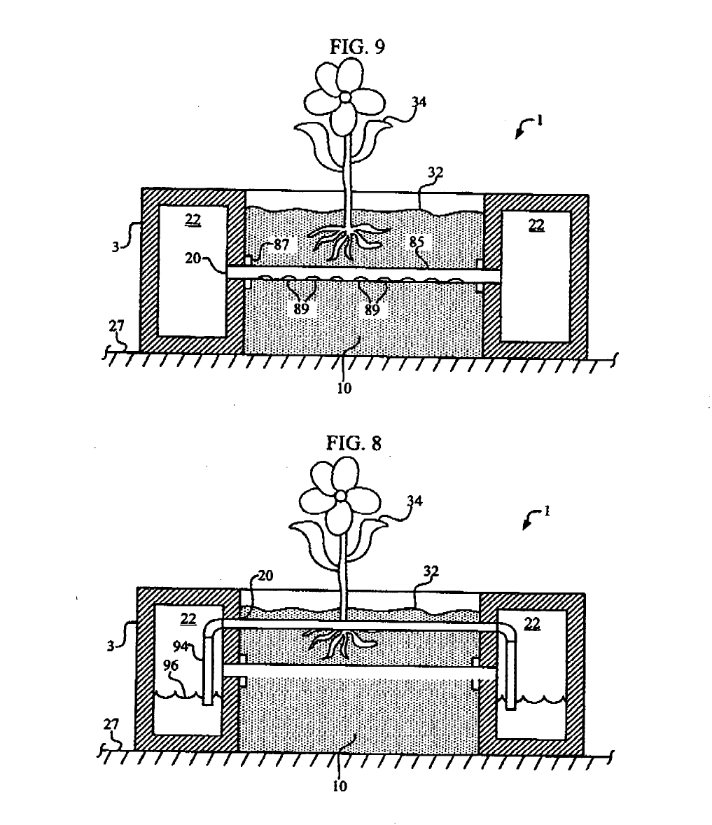

FIG. 8 is a cross-sectional view of planter 1 adapted to include an aeration system. Aeration system may include an aeration member 85 and flanges 87. Aeration member 85 may be any shape, may be partially hollow, and may include perforations 89 on the bottom portion of aeration member 85. Perforations 89 may facilitate additional air circulation into planting material 32. Aeration member 85 may be made of a material such as, but not limited to, PVC, plastic, metal, wood, and all equivalents. Aeration member 85 may be mounted to wall 3 via flange 87. Flange 87 may have a hole to allow air to circulate from cavity 22 of wall 3 into aeration member 85.

In an exemplary embodiment, planter 1 may include three aeration members 85 that span planting space 10 and are evenly spaced within planter 1. Aeration members 85 may be positioned at a depth of approximately five inches below the surface of planting material 32 if planting material 32 has sufficient depth.

FIG. 9 is a cross-sectional view of planter 1 adapted to include a cloth water wick system. Wicking system may include a cloth water wick 94. Cloth water wick 94 may pass through aperture 20 in wall 3 and may extend into cavity 22 of wall 3. Cavity 22 may include a reservoir of moisture 96 that cloth water wick 94 wicks to supply planting material 32 with moisture. Moisture from reservoir 96 may travel along cloth water wick 94 and be deposited in planting material 32.

In an exemplary embodiment, planter 1 may include three cloth water wicks 94 that span planting space 10 and are evenly spaced within planter 1. Cloth water wicks 94 may be positioned at a depth of approximately four inches below the surface of planting material 32 if planting material 32 has sufficient depth.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A planter, comprising:
a plurality of walls, wherein at least one wall includes a first aperture;
a first liquid permeable cover to traverse the first aperture;
a connection means for connecting two or more walls; and
a planting space at least partially defined by the plurality of walls.

2. The planter of claim 1 wherein the at least one wall further includes,
a first outer surface, and
a first internal cavity, wherein the first aperture extends from the outer surface to said first internal cavity.

3. The planter of claim 1, wherein each wall of the plurality of walls includes a first end and a second end, and wherein the connection means connects a first end of a first wall to a second end of a second wall.

4. The planter of claim 3, wherein the connection means is adjustable to vary the angle between the first wall and said second wall.

5. The planter of claim 3, wherein the connection means includes:
a second aperture;
a second outer surface; and
a second internal cavity, wherein said second aperture extends from the second outer surface of the connection means to the second internal cavity of the connection means.

6. The planter of claim 5, wherein the first internal cavity of the at least one wall connects to the second internal cavity of the connection means.

7. The planter of claim 1, wherein the planter is adapted to engage a framework, the framework having a frame including a plurality of frame members and a lattice attached to the frame, wherein the framework is pivotally coupled to the planter.

8. The planter of claim 7, wherein the framework includes a support, the supports holds the framework in place and prevents the framework from pivoting.

9. The planter of claim 7, wherein the frame is divided into an upper frame and a lower frame, the upper frame and the lower frame are pivotally coupled.

10. The planter of claim 7, wherein the framework is collapsible.

11. A raised bed planter, comprising:
a plurality of walls, each of the walls having an outer surface, a first end and a second end, a cavity positioned between the first end and the second end, and at least one aperture extending from the outer surface to the cavity;
a liquid permeable cover to traverse the at least one aperture; and
a connection means for connecting a first end of a first wall to a second end of a second wall.

12. The raised bed planter of claim 11 adapted to engage a framework; and
an attachment means for coupling the framework to the raised bed planter.
